(19) United States
(12) Patent Application Publication
(10) Pub. No.: US 2023/0354402 A1
(43) Pub. Date: Nov. 2, 2023

(54) SIDELINK PRIORITIZATION METHOD, USER EQUIPMENT, AND BASE STATION

(71) Applicant: JRD COMMUNICATION (SHENZHEN) LTD., Shenzhen, Guangdong (CN)

(72) Inventors: Xiaoxue Yin, Shenzhen, Guangdong (CN); Jia Sheng, Shenzhen, Guangdong (CN)

(73) Assignee: JRD COMMUNICATION (SHENZHEN) LTD., Shenzhen, Guangdong (CN)

(21) Appl. No.: 17/754,799

(22) PCT Filed: Oct. 28, 2019
(86) PCT No.: PCT/CN2019/113769

§ 371 Date: Apr. 12, 2022

(51) Int. Cl. H04W 72/56; H04W 72/0453

(52) U.S. Cl. CPC H04W 72/56; H04W 72/0453; H04W 92/18

(57) ABSTRACT

A sidelink prioritization method executable in a user equipment (UE) is disclosed. Upon receiving an initial priority value of a sidelink service, the UE determines a traffic type of the side link channel and generates a refined priority value of the sidelink service from the initial priority value according to the traffic type of the sidelink service.

### BACKGROUND OF DISCLOSURE

### 1. Field of Disclosure

The present disclosure relates to the field of communication systems, and more particularly, to a sidelink prioritization method, user equipment, and base station.

### 2. Description of Related Art

Wireless communication systems, such as the third-generation (3G) of mobile telephone standards and technology are well known. Such 3G standards and technology have been developed by the Third Generation Partnership Project (3GPP). The 3rd generation of wireless communications has generally been developed to support macro-cell mobile phone communications. Communication systems and networks have developed towards being a broadband and mobile system. In cellular wireless communication systems, user equipment (UE) is connected by a wireless link to a radio access network (RAN). The RAN comprises a set of base stations (BSs) which provide wireless links to the UEs located in cells covered by the base station, and an interface to a core network (CN) which provides overall network control. As will be appreciated the RAN and CN each conduct respective functions in relation to the overall network. The 3rd Generation Partnership Project has developed the so-called Long Term Evolution (LTE) system, namely, an Evolved Universal Mobile Telecommunication System Territorial Radio Access Network, (E-UTRAN), for a mobile access network where one or more macro-cells are supported by a base station known as an eNodeB or eNB (evolved NodeB). More recently, LTE is evolving further towards the so-called 5G or NR (new radio) systems where one or more cells are supported by a base station known as a gNB. NR is proposed to utilize an Orthogonal Frequency Division Multiplexed (OFDM) physical transmission format. In conventional cellular communication networks, all signaling is between each mobile device and a base station rather than directly between mobile devices, even if the mobile devices are within wireless communication range of each other. This may lead to inefficient use of wireless transmission resources and may increase base station resource utilization. Sidelink communications allow mobile devices to communicate directly rather than via a base station, potentially improving wireless and base station resource utilization. Sidelink communications are considered particularly interesting for machine to machine communications, particularly vehicle to vehicle (V2V) and vehicle to everything/anything (V2X) communications. The disclosure below relates to various improvements to cellular wireless communications systems, and in particular sidelink communications in such systems.

### SUMMARY

An object of the present disclosure is to propose a sidelink prioritization method, user equipment, and base station.

A first aspect of the present disclosure provides a sidelink prioritization method executable in a user equipment (UE), comprising: receiving an initial priority value of a sidelink service; determining a traffic type of the side link channel; and generating a refined priority value of the sidelink service from the initial priority value according to the traffic type of the sidelink service.

A second aspect of the present disclosure provides a sidelink prioritization method executable in a base station, comprising: receiving an initial priority value of a sidelink service; determining a traffic type of the side link channel; generating a refined priority value of the sidelink service from the initial priority value according to the traffic type of the sidelink service; and providing the refined priority value as a part of sidelink control information (SCI) associated with the sidelink service.

A third aspect of the present disclosure provides a UE device comprising a processor configured for executing the steps of: receiving an initial priority value of a sidelink service; determining a traffic type of the side link channel; and generating a refined priority value of the sidelink service from the initial priority value according to the traffic type of the sidelink service.

A fourth aspect of the present disclosure provides a base station comprising a processor configured for executing the steps of a processor configured for executing the steps of: receiving an initial priority value of a sidelink service; determining a traffic type of the side link channel; generating a refined priority value of the sidelink service from the initial priority value according to the traffic type of the sidelink service; and providing the refined priority value as a part of SCI associated with the sidelink service.

Non-transitory computer readable medium storing a computer executable program for realizing the disclosed method may comprise at least one from a group consisting of: a hard disk, a CD-ROM, an optical storage device, a magnetic storage device, a Read Only Memory, a Programmable Read Only Memory, an Erasable Programmable Read Only Memory, EPROM, an Electrically Erasable Programmable Read Only Memory and a Flash memory.

### BRIEF DESCRIPTION OF DRAWINGS

In order to more clearly illustrate the embodiments of the present disclosure or related art, the following figures will be described in the embodiments are briefly introduced. It is obvious that the drawings are merely some embodiments of the present disclosure, a person having ordinary skill in this field can obtain other figures according to these figures without paying the premise.

FIG. 1 illustrates a schematic view of a telecommunication system.

FIG. 2 illustrates a sidelink prioritization method according to an embodiment of the present disclosure.

FIG. 3 illustrates a sidelink prioritization method according to another embodiment of the present disclosure.

FIG. 4 illustrates a sidelink prioritization method according to yet another embodiment of the present disclosure.

FIG. 5 is a block diagram of a system for wireless communication according to an embodiment of the present disclosure.

### DETAILED DESCRIPTION OF EMBODIMENTS

Embodiments of the disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

Fifth-generation (5G) wireless systems are generally a cellular communication system in a frequency range 2 (FR2) ranging from 24.25 GHz to 52.6 GHz, where multiplex transmit (Tx) and receive (Rx) beams are employed by a base station (BS) and/or a user equipment (UE) to combat a large path loss in a high frequency band. Due to hardware limitations and costs, the BS and the UE might only be equipped with a limited number of transmission and reception units (TXRUs).

The main idea of the disclosure is to provide a new design for quality of service (QoS) management. QoS management is relevant to V2X in the context of resource allocation, congestion control, in-device coexistence, power control and sidelink radio bearer (SLRB) configuration. Physical layer parameters related to QoS management may include the priority, latency, reliability, and minimum required communication range as defined by higher layers of the traffic being delivered. For SL unicast, groupcast and broadcast, QoS parameters of V2X packets are provided by upper layers to the Access Stratum (AS).

Any UE configured to receive a group destination Layer 2 identifier (ID) is allowed to receive the groupcast transmission, whether within or beyond a “minimum communication range” provided by upper layers.

The sidelink transmissions from different traffic types, such as unicast, groupcast, and broadcast, may be treated differently, which leads to different priorities for traffic types. A more flexible mechanism is proposed in the disclosure, and sidelink transmission of each traffic type may have a configurable priority to meet different communication cases and QoS requirements. The disclosure proposes QoS management mechanism considering traffic types for Non-Access Stratum (NAS) layers and/or AS layers. For a specific communication case such as congestion control, starvation avoidance, sensing procedure, and pre-emption, the specific traffic type may need higher priority to guarantee the quality of transmission and improve QoS for a given priority level.

For the purpose of balancing dropping events between traffic priorities and traffic types in the case of channel congestion, the disclosure provides a solution in physical layer to take into account the traffic type in distributed congestion control (DCC), and a CR-limit bonus is proposed for groupcast and broadcast.

Differentiation of traffic types and priority information of each transmission can be determined in higher layers, where higher layers may distinguish the traffic type and modify the priority information, and a physical layer can use the priority information incorporating the information of traffic types. A higher layer may include a layer above a physical layer in a protocol stack. For example, in LTE protocol stack, the higher layers may include medium access control (MAC), radio link control (RLC), packet data convergence protocol (PDCP), radio resource control (RRC), and non-access stratum (NAS). In addition, QoS handling in physical layer may lead to a very brutal solution at an air interface, such as dropping transmission for congestion control, while QoS handling in higher layers is more flexible.

The main idea of the disclosure is to provide a new design for QoS management, where prioritization process of each sidelink transmission may take traffic types into account. In some specific transmission cases, such as congestion control, starvation avoidance, sensing procedure, and pre-emption, the specific traffic type may need a refined priority higher or lower than an assigned initial priority. For example, in a specific scenario, since the QoS impact of groupcast or broadcast on packet drop is multiple times than those of unicast, groupcast and broadcast need higher priority to meet QoS requirements. In another example, for an emergent unicast transmission task needs the highest priority to guarantee the quality of transmission. Accordingly, a flexible QoS management with a configurable relationship between priority and traffic type is needed. The mechanism may be utilized to meet different scenarios and improve robustness. In the disclosure, several solutions are proposed at Non-Access Stratum (NAS) layers and/or AS layers to provide QoS management mechanism considering traffic types.

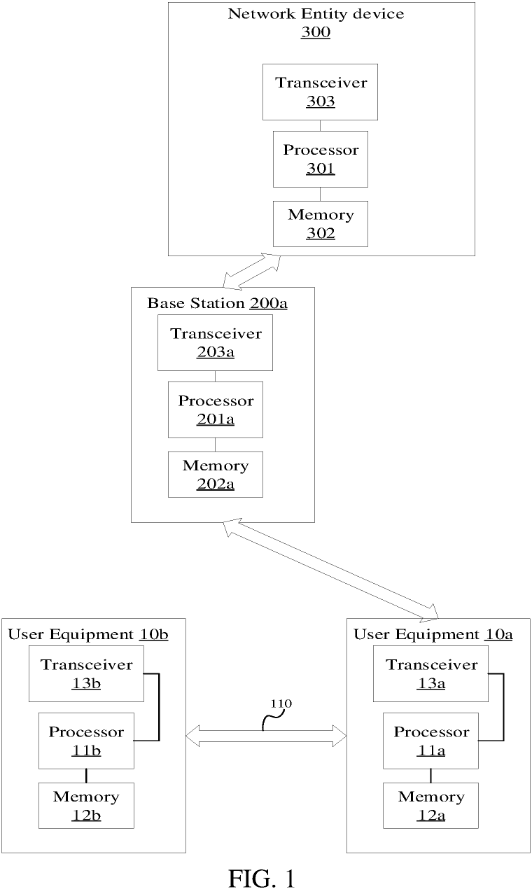

With reference to FIG. 1, a UE 10a, a UE 10b, a base station 200a, and a network entity device 300 executes a sidelink prioritization method according to an embodiment of the present disclosure. Connections between devices and device components are shown as lines and arrows in the FIG. 1. The UE 10a may include a processor 11a, a memory 12a, and a transceiver 13a. The UE 10b may include a processor 11b, a memory 12b, and a transceiver 13b. The base station 200a may include a processor 201a, a memory 202a, and a transceiver 203a. The network entity device 300 may include a processor 301, a memory 302, and a transceiver 303. Each of the processors 11a, 11b, 201a, and 301 may be configured to implement proposed functions, procedures and/or methods described in this description. Layers of radio interface protocol may be implemented in the processors 11a, 11b, 201a, and 301. Each of the memory 12a, 12b, 202a, and 302 operatively stores a variety of program and information to operate a connected processor. Each of the transceiver 13a, 13b, 203a, and 303 is operatively coupled with a connected processor, transmits and/or receives a radio signal. The UE 10a is in communication with the UE 10b through a sidelink 110. The base station 200a may be an eNB, a gNB, or one of other radio nodes, and may configure the sidelink 110 between the UE 10a and UE 10b.

Each of the processor 11a, 11b, 201a, and 301 may include an application-specific integrated circuits (ASICs), other chipsets, logic circuits and/or data processing devices. Each of the memory 12a, 12b, 202a, and 302 may include a read-only memory (ROM), a random access memory (RAM), a flash memory, a memory card, a storage medium and/or other storage devices. Each of the transceiver 13a, 13b, 203a, and 303 may include baseband circuitry and radio frequency (RF) circuitry to process radio frequency signals. When the embodiments are implemented in software, the techniques described herein can be implemented with modules, procedures, functions, entities and so on, that perform the functions described herein. The modules can be stored in a memory and executed by the processors. The memory can be implemented within a processor or external to the processor, in which those can be communicatively coupled to the processor via various means are known in the art.

The communication between UEs may be realized according to device to device (D2D) communication or vehicle-to-everything (V2X) communication. V2X communication includes vehicle-to-vehicle (V2V), vehicle-to-pedestrian (V2P), and vehicle-to-infrastructure/network (V2I/N) according to a sidelink technology developed under 3rd generation partnership project (3GPP) release 14, 15, 16, and beyond. UEs communicate with each other directly via a sidelink interface such as a PC5 interface.

The network entity device 300 may be a node in a CN. CN may include LTE CN or 5GC which includes user plane function (UPF), session management function (SMF), mobility management function (AMF), unified data management (UDM), policy control function (PCF), control plane (CP)/user plane (UP) separation (CUPS), authentication server (AUSF), network slice selection function (NSSF), and the network exposure function (NEF).

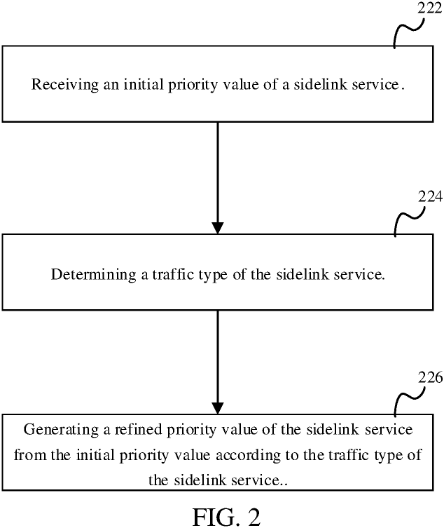

With reference to FIG. 2, a UE device, such as one of the UE 10a and UE 10b includes a processor configured for executing a sidelink prioritization method. According to an embodiment of the method, the UE receives an initial priority value of a sidelink service, such as the sidelink 110 (block 222), and determines a traffic type of the side link channel (block 224). The UE generates a refined priority value of the sidelink service from the initial priority value according to the traffic type of the sidelink service (block 226). The initial priority value of the sidelink service is represented by a ProSe per-packet priority (PPPP), a ProSe per-packet reliability (PPPR), or a combination of the PPPP and PPPR. The initial priority value of the sidelink service is a priority used in access stratum (AS), non-access stratum (NAS), logical channel allocation, or channel busy ratio (CBR) range processing. Embodiments of the invention may be derived from any combination of the following solutions.

Non-access stratum (NAS) is a functional layer in the communication systems such as Universal Mobile Telecommunications System (UMTS) and LTE wireless telecom protocol stacks between the core network and user equipment (UE). NAS layer is used to manage the establishment of communication sessions and for maintaining continuous communication with UE device in mobility. The NAS is defined in contrast to the access stratum (AS) which is responsible for carrying information over the radio access networks. NAS is a protocol for messages passed between the UE and CN entities. CN entities are also known as core nodes such as Mobile Switching Center (MSC), Serving GPRS Support Node (SGSN), and Mobility Management Entity (MME). NAS messages are passed transparently through the RAN. Examples of NAS messages include Update or Attach messages, Authentication Messages, and Service Requests. Once a UE establishes a radio connection, the UE uses the radio connection to communicate with core nodes to coordinate service. Access stratum is used explicitly between UE and radio network while the NAS is used between the UE and core nodes.

Access stratum is a functional layer in telecommunication systems such as UMTS and LTE wireless telecom protocol stacks between radio network and UE. While the definition of the access stratum of LTE is very different from UMTS, the access stratums in both LTE and UMTS are responsible for transporting data over the wireless connection and managing radio resources.

In the following, prioritization processes in NAS and AS are provided to differentiate QoS grants on sidelink transmissions. In the disclosure, traffic types include unicast, groupcast, broadcast and others, the number of traffic types is represented by a parameter TrafficTypeNum which is configurable, and a specific traffic type is represented by the parameter TrafficType x.

The disclosed method may be applied in NAS as detailed in the following.

5G QoS Identifier (5QI) is a scalar that is used as a reference to a specific QoS forwarding behavior, such as packet loss rate, and packet delay budget, to be provided to a 5G QoS flow. 5QI may be implemented in an access network by 5QI referencing node specific parameters that control the QoS forwarding treatment, such as scheduling weights, admission thresholds, queue management thresholds, and link layer protocol configuration. The PC5 QoS characteristics associated with PC5 5QI (PQI) including priority have the same format and meaning as that of ProSe per-packet priority (PPPP) defined in technical specification (TS) 23.285. When a ProSe upper layer above PC5 access stratum passes a protocol data unit (PDU) for transmission to the PC5 access stratum, the ProSe upper layer provides a PPPP in a range of 8 possible values. A UE, such as the UE 10a or the UE 10b, may be configured with one PPPP value as the initial priority value for transmitting PC5-S messages as described in 3GPP 23.303 clause 4.5.1.1.2.3.1.

Different priority levels may be used to V2X service data across different modes of communication, such as broadcast, groupcast, and unicast. When QoS requirements cannot be fulfilled for all PC5 service data, priority level is used as a prioritization baseline for differentiating data processing. For example, PC5 service data with lower Priority Level value N is prioritized over PC5 service data with higher Priority Level values, such as N+ 1, N+2, ... and the similar. A priority level with lower value means higher priority.

In order to treat traffic types in different scenarios, an identifier CastTypeFlag is defined and is configured by upper layers. CastTypeFlag is n-bit identifier used to determine if traffic type of a sidelink service is considered in determination of a priority level of a sidelink service, where n >= 1. In one embodiment, CastTypeFlag is one bit, that is n = 1. CastTypeFlag =1 means that the priority level includes the information of the traffic type.

If the traffic type is to be considered with the Priority Level, the Priority Level may be divided into three degrees: high priority, medium priority and low priority. Each degree including several consecutive priority levels, and each level corresponds to a specific traffic type.

With reference to Table 1, for example, in case of TrafficTypeNum = 3, traffic flows of three traffic types, such as unicast, groupcast and broadcast, are treated with differentiated QoS. With n-bit parameter PPPP, where n=3 in the example, each of high priority degree and medium priority degree has three priority levels. In low priority degree, groupcast and broadcast are associated with the same priority level. The specific mapping relationship between priority and traffic types can be configured by a telecom operator. Table 1 is an example of a descending priority order of traffic types such as provided by operators.

TABLE 1

| Priority degree | Priority Level | PPPP | Traffic Type |
|---|---|---|---|
| High priority | 1 | PPPP1 | Broadcast |
| | 2 | PPPP2 | Groupcast |
| | 3 | PPPP3 | Unicast |
| Medium priority | 4 | PPPP4 | Broadcast |
| | 5 | PPPP5 | Groupcast |
| | 6 | PPPP6 | Unicast |
| Low priority | 7 | PPPP7 | Broadcast/Groupcast |
| | 8 | PPPP8 | Unicast |

As shown in Table 2, in an alternative embodiment where CastTypeFlag is 2 bits, that is n = 2, and different values of the CastTypeFlag correspond to the different prioritization processes of the traffic types:

TABLE 2

| CastTypeFlag | Prioritization process |
|---|---|
| 00 | Traffic type is not taken into account in prioritization process |
| 01 | Differentiated prioritization process on unicast and non-unicast |
| 10 | Differentiated prioritization process on unicast, groupcast, and broadcast |
| 11 | Differentiated prioritization process on unicast, groupcast, and broadcast, and further differentiated prioritization process on groupcast based on the number of group members involved in the groupcast. |

The disclosed method may be applied in AS as detailed in the following.

The V field in a medium access control (MAC) header for a sidelink shared channel (SL-SCH) indicates which version of the SL-SCH sub-header is used. For V2X sidelink communication, if the V field is set to “0001”, this identifier is a groupcast identifier. If the V field is set to “0010”, this identifier is a unicast identifier. Information about traffic type can be thus obtained from the V field.

The information element (IE) SL-Priority indicates the one or more priorities associated with a MAC layer resource pool used for sidelink communication, and the value of SL-Priority is derived from PPPP. PPPP is scalar value associated with a protocol data unit that defines the priority handling to be applied for transmission of that protocol data unit. In an embodiment, the SL-Priority may be used to prioritize V2X service data across different traffic types. A physical layer in a UE follows configuration of SL-Priority .

A solution with new design of the SL-Priority and Logical Channel Group (LCG) is detailed in the following. Each sidelink logical channel is allocated to a logical channel group (LCG) depending on a priority, such as SL-priority, and optionally the ProSe per-packet reliability (PPPR) of the sidelink logical channel. PPPR is a scalar value associated with a protocol data unit that defines the reliability to be applied for transmission of that protocol data unit. The upper layers provide mapping between an LCG identifier (ID) and a priority value of a logic channel, such as the PPPR of the logic channel, in logicalChGroupInfoList. Traffic type may be used in the channel allocation. Each LCG is associated with ProSe Destination. The following description start from two perspectives- SL-priority and allocation of logical channel.

A solution with a priorityOffset for the SL-Priority is detailed in the following. Allocation of logical channel is based on the SL-Priority. In the embodiment, an n-bit parameter priorityOffset is utilized for SL-Priority value, where n ≥ 1. Each SL-Priority value represents a priority level, and the lower the SL-Priority value the higher the priority. The priorityOffset may be associated with different traffic types separately and may be configured for different situations.

A first option of using the priorityOffset is for differentiation between unicast and non-unicast transmission.

The priorityOffset parameter may represent unicast and non-unicast transmission. In one embodiment, priorityOffset is a one-bit parameter. The value of priorityOffset is either one in {0, 1}, which can be utilized to adjust the SL-Priority to generate a refined priority value SL -Priority (i) as shown in the following formula:

$$S L - P r i o r i t y \left(\text{i}\right) = min \left\{\left(\text{PPPP} \left(\text{i}\right) - p r i o r i t y O f f s e t \left(j\right)\right) , 1\right\} , \qquad \text{(1)}$$

where i ∈ {1, 2, ... 8}

$$p r i o r i t y O f f s e t \left(j\right) = j , \qquad \text{(2)}$$

where j ∈ {0, 1}

For example, the value of priorityOffset may be configured as:

$$p r i o r i t y O f f s e t = \left\{\begin{matrix}0 , u n i c a s t \\ 1 , n o n - u n i c a s t\end{matrix}\right) \qquad \text{(3)}$$

Alternatively, the value of priorityOffset may be configured as:

$$p r i o r i t y O f f s e t = \left\{\begin{matrix}0 , n o n - u n i c a s t \\ 1 , u n i c a s t\end{matrix}\right) \qquad \text{(4)}$$

The variable i is a PPPP index. A second option of using the priorityOffset is for differentiation between non-unicast transmissions by the number of group members.

The priorityOffset may represent the unicast traffic type and a plurality of non-unicast traffic types. The non-unicast traffic types in a UE group having a number of UE members may be categorized into at least two traffic types according to the number of UE group members. A priority level of SL-Priority can be modified to generate a refined priority value using priorityOffset based on the traffic types and the number of group member. In an alternative embodiment, priorityOffset is a 2-bit parameter, and the SL-Priority can be modified according to the following formula:

$$S L - P r i o r i t y \left(\text{i}\right) = min \left\{\left(\text{PPPP} \left(\text{i}\right) - p r i o r i t y O f f s e t \left(j\right)\right) , 1\right\} , \qquad \text{(5)}$$

where

$$\text{i} ∈ \left\{1 , 2 , … 8\right\}$$

$$p r i o r i t y O f f s e t \left(j\right) = j , \qquad \text{(6)}$$

where

$$\text{j} ∈ \left\{0 , 1 , 2 ,\right\}$$

A configurable parameter groupmemberThre may be utilized as a threshold to distinguish one to many transmission, that is non-unicast traffic types. A parameter membernum represents the number of group members. For example, the priorityoffset may be configured according to the following formula:

$$\begin{matrix}p r i o r i t y O f f s e t = \\ \left\{\begin{matrix}0 , u n i c a s t \\ 1 , n o n - u n i c a s t , a n d m e m b e r n u m < g r o u p m e m b e r T h r e \\ 2 , n o n - u n i c a s t , a n d m e m b e r n u m \geq g r o u p m e m b e r T h r e\end{matrix}\right)\end{matrix} \qquad \text{(7)}$$

The mapping relationship is configurable.

A third option of using the priorityOffset is for differentiation between traffic types.

In an alternative embodiment, priorityOffset is a 2-bit parameter. The value of priorityOffset is a value selected from {0,1,2} Priority level of SL-Priority can be modified using priorityOffset based on the traffic types and the number of group member according to the following formula shows. The mapping relationship is configurable.

$$S L - P r i o r i t y \left(\text{i}\right) = min \left\{\left(\text{PPPP} \left(\text{i}\right) - p r i o r i t y O f f s e t \left(j\right)\right) , 1\right\} , \qquad \text{(8)}$$

where

$$\text{i} ∈ \left\{1 , 2 , … 8\right\}$$

$$p r i o r i t y O f f s e t \left(j\right) = j \qquad \text{(9)}$$

where

$$j ∈ \left\{0 , 1\right\}$$

$$p r i o r i t y O f f s e t = \left\{\begin{matrix}0 , T r a f f i c T y p e \text{1} \\ 1 , T r a f f i c T y p e \text{2} \\ 2 , T r a f f i c T y p e \text{3}\end{matrix}\right) \qquad \text{(10)}$$

For example, in congestion control, packet drop impact on groupcast or broadcast in feedback channels is several times than unicast. In this case, the priorityOffset of groupcast and broadcast may be increased while the unicast traffic type is associated with priorityOffset (0) to keep the priority of the unicast at the original level. The priorityOffset for groupcast may be 1, and the priorityOffset for broadcast may be 2 as shown in following formula:

$$p r i o r i t y O f f s e t = \left\{\begin{matrix}0 , u n i c a s t \\ 1 , g r o u p c a s t \\ 2 , b r o a d c a s t\end{matrix}\right) \qquad \text{(11)}$$

An embodiment of the disclosed method may be applied to logical channel allocation and is detailed in the following.

An embodiment of the invention is to modify the SL-Priority based on traffic types. An alternative embodiment of the invention provides sidelink logical channel allocation based on traffic types with a SL-Priority staying at the original level.

Each sidelink logical channel may be allocated to an LCG, and the allocation depends on the priority and traffic type of the sidelink logical channel. In LTE, the mapping between an ID of an LCG and the priority of the LCG is provided by upper layers in logicalChGroupInfoList . The logicalChGroupInfoList indicates for each LCG a list of associated priority levels. In the embodiment, the number of traffic types are included in logicalChGroupInfoList, as an example shown in the Table 3:

TABLE 3

| | |
|---|---|
| LogicalChGroupInfoList ::= | SEQUENCE (SIZE (1..maxLCG × TrafficTypeNum)) OF |

SL-PriorityList

The value of TrafficTypeNum is configurable and is in a range from 1 to m, where m≥1. In one embodiment where m=3, TrafficTypeNum = 1 means the traffic type is not take into account in the prioritization process, TrafficTypeNum = 2 means the prioritization processes of traffic types are differentiated based on unicast and non-unicast, TrafficTypeNum = 3 means the prioritization processes of traffic types are differentiated based on all the three kinds of traffic types.

In an example where TrafficTypeNum = 3, association between LCG and SL-priority is shown in Table 4 in an arrangement of ascending logical channel group identities:

TABLE 4

| | | |
|---|---|---|
| Traffic Type | Logical Channel Group (LCG) | SL-priorityList |
| Traffic Type 1 | LCG(0) | SL-priorityList(0) |
| | LCG(1) | SL-priorityList(1) |
| | ... | ... |
| | LCG(maxLCG-1) | SL-priorityList(maxLCG-1)) |
| Traffic Type 2 | LCG(0) | SL-priorityList(0) |
| | LCG(1) | SL-priorityList(1) |
| | ... | ... |
| | LCG(maxLCG-1) | SL-priorityList(maxLCG-1)) |
| Traffic Type 3 | LCG(0) | SL-priorityList(0) |
| | LCG(1) | SL-priorityList(1) |
| | ... | ... |
| | LCG(maxLCG-1) | SL-priorityList(maxLCG-1)) |

The parameter maxLCG is an integer representing the total number of logical channel groups. The mapping relationship between the parameter TrafficType x and real traffic types is configurable.

Alternatively, the LCG for a traffic type in the 2^{nd} column of the Table 4 may include LCG(0), LCG(1),...,LCG(TrafficTypeNum×maxLCG-1). The SL-priorityList for a traffic type in the 3^{rd} column of the Table 4 may include SL-priorityList(0), SL-priorityList (1),..., SL-priorityList (TrafficTypeNum×maxLCG-1). TrafficTypeNum represents the number of traffic types. In the example of the Table 4, TrafficTypeNum = 3. Any combination of the expressions above could be possible.

An embodiment of the disclosed method may be applied to logical channel prioritization and is detailed in the following.

A sidelink logical channel for new transmission is prioritized according to a sidelink logical channel prioritization process. Each sidelink logical channel has an associated priority represented by a PPPP and optionally an associated PPPR. If multiple sidelink logical channels have the same priority, traffic types of the sidelink logical channels are taken into account in prioritization processes of the channels to meet different situations. Prioritization of traffic types includes first determining the traffic type of a sidelink logical channel. Each traffic type has a list of priorities of logical channels.

A descending priority arrangement of traffic types is from TraffickType1 to TraffickType3, and the mapping relationship between parameter TraffickType x and the traffic types is configured by higher layers.

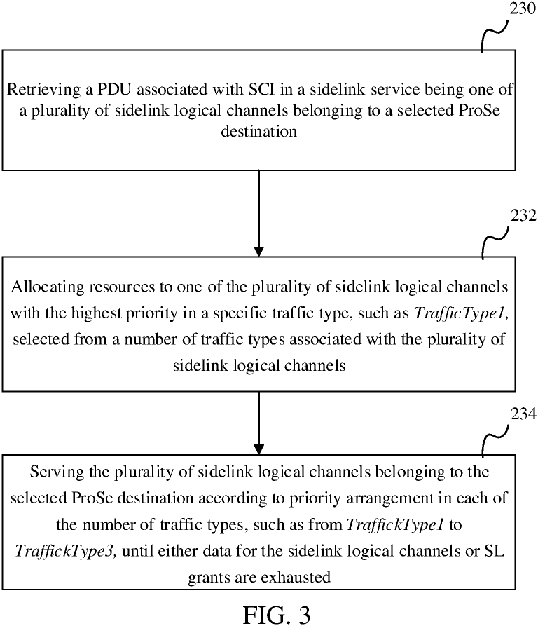

With reference to FIG. 3, a processing entity, such as a MAC layer, in a UE, such as one of the UE 10a and UE 10b, performs the following logical channel prioritization process either for each sidelink control information (SCI) transmitted in a sidelink control (SC) period in sidelink communication, or for each SCI corresponding to a new transmission in V2X sidelink communication. The MAC layer may be implemented by computer program for execution by a processor of the UE.
Retrieving a PDU, such as a MAC PDU, associated with SCI in a sidelink service being one of a plurality of sidelink logical channels belonging to a selected ProSe destination (block 230);
Allocating resources to one of the plurality of sidelink logical channels with the highest priority in a specific traffic type, such as TrafficType1, selected from a number of traffic types associated with the plurality of sidelink logical channels (block 232);
if resources are available, serving the plurality of sidelink logical channels belonging to the selected ProSe destination according to priority arrangement in each of the number of traffic types, such as from TraffickType1 to TraffickType3, until either data for the sidelink logical channels or SL grant is exhausted, whichever comes first (block 234). Sidelink logical channels configured with equal priority should be served equally.

Data for the sidelink logical channels is determined as exhausted when no more data for the sidelink logical channels are available for the priority processing. SL grant is determined as exhausted when no more SL grant are available for the sidelink logical channels. For example, in a specific situation, the broadcast traffic type maybe of top priority, the TrafficType1 may corresponds to the broadcast traffic type, TrafficType2 corresponds to the groupcast traffic type, and TrafficType3 corresponds to the unicast traffic type. The descending priority arrangement is shown as the following table:

TABLE 5

| | |
|---|---|
| Traffic Type | Priority |
| Broadcast | PPPP1 |
| | PPPP2 |
| | ... |
| | PPPP8 |
| Groupcast | PPPP1 |
| | PPPP2 |
| | ... |
| | PPPP8 |
| Unicast | PPPP1 |
| | PPPP2 |
| | ... |
| | PPPP8 |

An embodiment of the disclosed method may be applied to channel busy ratio (CBR) range processing as detailed in the following.

In an embodiment, the information element (IE) SL-CBR-CommonTxConfigList indicates a list of physical sidelink shared channel (PSSCH) transmission parameters, such as a modulation and coding scheme (MCS), a sub-channel number, a retransmission number, and a CR-limit, in sl-CBR-PSSCH-TxConfigList, and a list of channel busy ratio (CBR) ranges in cbr-RangeCommonConfigList. A UE may use IE SL-CBR-CommonTxConfigList to configure congestion control for V2X sidelink communication.

The entries in cbr-RangeCommonConfigList and a mapping relationship between cbr-ConfigIndex and SL-CBR-Levels-Config may be configured as shown in the following Table 6. The cbr-ConfigIndex is in SL-CBR-PPPP-TxConfigList and cbr-RangeCommonConfigList:

TABLE 6

| | |
|---|---|
| cbr-ConfigIndex | SL-CBR-Levels-Config |
| 0 | ${R}_{1}^{0} , {R}_{2}^{0} , ... , {R}_{\text{maxCBR} - \text{Level}}^{0}$ |
| 1 | ${R}_{1}^{1} , {R}_{2}^{1} , ... , {R}_{\text{maxCBR} - \text{Level}}^{1}$ |
| ... | ... |
| maxSL-V2X-CBRConfig - 1 | ${R}_{1}^{n} , {R}_{2}^{n} , ... , {R}_{\text{maxCBR} - \text{Level}}^{n}$ |

The parameter maxSL-V2X-CBRConfig represents the maximum number of CBR range configurations. 3GPP TS 36.331 v15.6.0 defines maxSL-V2X-CBRConfig = 4. The parameter maxCBR-Level represents the maximum number of CBR levels. 3GPP TS 36.331 v15.6.0 defines maxCBR-Level=16. In Table 6, n = maxSL-V2X-CBRConfig.

$${R}_{y}^{x}$$

represents each entry of SL-CBR-Levels-Config, where x represents a cbr-ConfigIndex value, and y represents the index of a CBR level. Each CR-limit in SL-CBR-PSSCH-TxConfig in sl-CBR-PSSCH-TxConfigList is indicated by an index in tx-ConfiglndexList and sequentially maps to a CBR range indicated by cbr-ConfigIndex. The parameter tx-ConfigIndexList is a parameter in SL-CBR-PPPP-TxConfigList which is related to CR-limit. Both CR-limit and priority are used to determine a CBR range in the case of congestion control. NR V2X new features such as traffic types may impact the distributed congestion control (DCC) process and is needed in determination of CBR range.

A first option of using traffic types in the CBR processing is applied for additional configuration for cbr-RangeCommonConfigList as detailed in the following.

Each traffic type corresponds to one of different kinds of CBR ranges. The cbr-RangeCommonConfigList in SL-CBR-CommonTxConfigList indicates list of CBR ranges. Each entry of the list indicates in SL-CBR-Levels-Config the upper bound of the CBR range for the respective entry. In order to incorporate traffic type into CBR range configuration, size of the list for CBR range may be expanded.

For example, the cbr-RangeCommonConfigList in SL-CBR-CommonTxConfigList and the cbr-ConfigIndex in SL-CBR-PPPP-TxConfigList may be modified as shown in Table 7 and Table 8. Table 7 shows an example of IE SL-CBR-CommonTxConfigList. Table 8 shows an example of IE SL-CBR-PPPP-TxConfigList.

TABLE 7

-- ASN1START
SL-CBR-CommonTxConfigList-r14 ::= SEQUENCE {
cbr-RangeCommonConfigList-r14 SEQUENCE (SIZE (1..maxSL-V2X-
CBRConfig×TrafficTypeNum)) OF SL-CBR-Levels-Config-r14,
sl-CBR-PSSCH-TxConfigList-r14 SEQUENCE (SIZE (1..maxSL-V2X-TxConfig-r14))
OF SL-CBR-PSSCH-TxConfig-r14
}

TABLE 8

-- ASN1START
SL-CBR-PPPP-TxConfigList-r14 ::= SEQUENCE (SIZE (1..8)) OF SL-PPPP-
TxConfigIndex-r14
SL-PPPP-TxConfigIndex-r14 ::= SEQUENCE {
priorityThreshold-r14 SL-Priority-r13,
defaultTxConfigIndex-r14 INTEGER(0..maxCBR-Level-1-r14),
cbr-ConfigIndex-r14 INTEGER(0.. (maxSL-V2X-
CBRConfig×TrafficTypeNum-1)),
tx-ConfigIndexList-r14 SEQUENCE (SIZE (1..maxCBR-Level-r14)) OF Tx
ConfigIndex-r14
}

The mapping between traffic type and cbr-ConfigIndex is shown in the following table:

TABLE 9

| | |
|---|---|
| TrafficType | cbr-ConfigIndex |
| TrafficType1 | 0 |
| | 1 |
| | ... |
| | maxSL-V2X-CBRConfig - 1 |
| TrafficType2 | maxSL-V2X-CBRConfig |
| | maxSL-V2X-CBRConfig +1 |
| | ... |
| | 2×maxSL-V2X-CBRConfig-1 |
| ... | ... |
| TrafficType m | (m - 1) ×maxSL-V2X-CBRConfig |
| | (m - 1) ×maxSL-V2X-CBRConfig +1 |
| | ... |
| | m ×maxSL-V2X-CBRConfig - 1 |

The value of TrafficTypeNum is from 1 to m and is configurable, where m≥1. In one embodiment where m=3, TrafficTypeNum = 1 means the traffic type is not take into account in the CBR range processing, TrafficTypeNum = 2 represents differentiated CBR range processing on unicast and non-unicast traffic types, TrafficTypeNum = 3 represents differentiated CBR range processing on the three traffic types. The specific traffic type for TrafficType x selected from TrafficType1 to TrafficType3 is configurable.

A second option of using traffic types in the CBR processing is to incorporate a field of traffic type in SL-CBR-CommonTxConfigList as detailed in the following.

As mentioned in option 1, the cbr-RangeCommonConfigList in SL-CBR-CommonTxConfigList indicates a list of CBR ranges, and each entry of the list indicates in SL-CBR-Levels-Config the upper bound of the CBR range for the respective entry. To incorporate traffic types, different traffic types may be distinguished by different entries in cbr-RangeCommonConfigList in SL-CBR-CommonTxConfigList. Each cbr-ConfigIndex may represent one of the traffic types and may be configurable. Table 10 shows an example of the cbr-RangeCommonConfigList:

TABLE 10

| | |
|---|---|
| cbr-ConfigIndex | Traffic Type |
| 0 | Traffic Type 1 |
| 1 | Traffic Type 2 |
| ... | ... |
| maxSL-V2X-CBRConfig-1 | Traffic Type n |

In table 10, n= maxSL-V2X-CBRConfig, and maxSL-V2X-CBRConfig represents the maximum number of CBR range configurations. 3GPP TS 36.331 v15.6.0 defines maxSL-V2X-CBRConfig = 4.

The mapping relationship between TrafficType x and a real traffic type is configurable. For example, Traffic type 1 may corresponds to unicast, Traffic type 2 may corresponds to groupcast, Traffic type 3 may corresponds to broadcast, and the redundant bits could be zero.

An embodiment of the disclosed method may be applied to redesign sidelink control information (SCI) as detailed in the following.

SCI transports sidelink scheduling information. The processing for SCI may follow the downlink control information (DCI). An indication of a priority of a sidelink transmission may be carried by SCI payload. A base station, such as the base station 200a, may determine a priority in SCI for a sidelink based on a traffic type of the sidelink. A processor of the base station, such as the base station 200a, may execute the disclosed method.

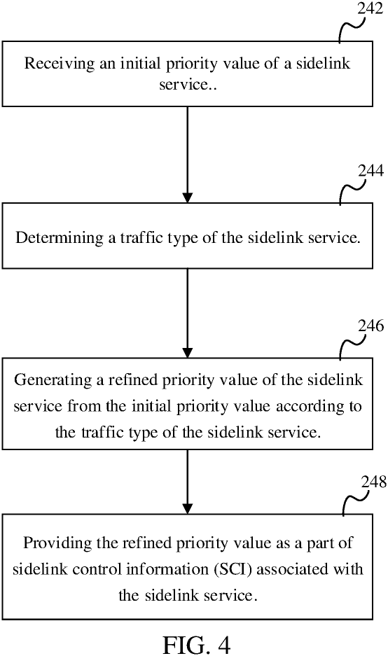

With reference to FIG. 4, a higher layer receives an initial priority value of a sidelink service, such as the sidelink 110 associated with two UE devices, such as the UE 10a and the UE 10b (block 242), and determines a traffic type of the side link channel (block 244). The higher layer generates a refined priority value of the sidelink service from the initial priority value according to the traffic type of the sidelink service (block 246) and provides the refined priority value as a part of SCI associated with the sidelink service (block 248). The higher layer may be a higher layer in the base station, or one of the UE 10a and the UE 10b.

A first option of using traffic types to redesign SCI is using a PriorityFlag parameter as detailed in the following.

An n-bits parameter PriorityFlag may be utilized to adjust an initial priority value in SCI of current sidelink transmission, where n ≥ 1. The initial priority value of the sidelink service may be represented by a PPPP, a PPPR, or a CBR range index. A refined priority value in SCI of a sidelink transmission may be obtained from a PPPP from higher layers minus the value of PriorityFlag. A lower PPPP number may represent higher priority. In one embodiment, if n=2 each value of PriorityFlag represents a level of priority adjustment as shown in the formula:

$$\text{PriorityFlag} = \left\{\begin{matrix}00 , n o c h a n g e o n t h e P P P P \\ 01 , p r i o r i t y u p g r a d e b y 1 l e v e l \\ 10 , p r i o r i t y u p g r a d e b y 2 l e v e l s \\ 11 , p r i o r i t y u p g r a d e b y 3 l e v e l s\end{matrix}\right) \qquad \text{(12)}$$

The parameter PriorityFlag serving as a priority offset may be configured by upper layers depending on the traffic types.

A second option of using traffic types to redesign SCI is using a traffic type identifier in SCI as detailed in the following.

An n-bit parameter TrafficTypeIdentifier may be added into SCI as a part of the SCI to represent one of the traffic types. The number of traffic types may be configured by higher layers. The TrafficTypeIdentifier may be configured to associate with a TrafficType x as shown in Table 11:

TABLE 11

| | |
|---|---|
| TrafficTypeIdentifier | Traffic Type |
| 00 | Traffic type1 |
| 01 | Traffic type2 |
| 10 | Traffic type3 |
| ... | ... |

The mapping relationship between a TrafficType value x and a real traffic type is configurable. For example, Traffic type 1 may corresponds to unicast, Traffic type 2 may corresponds to groupcast, and Traffic type 3 may corresponds to broadcast. The traffic type in SCI may be allocated a priority in priority processing as described on the embodiments of the disclosure.

A UE may modify QoS management with the information of traffic type for a specific scenario, such as for congestion control.

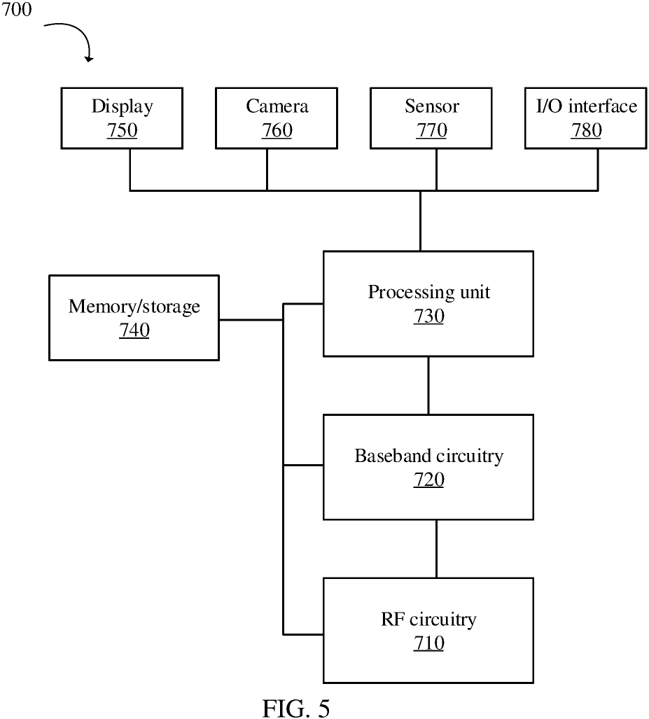

FIG. 5 is a block diagram of an example system 700 for wireless communication according to an embodiment of the present disclosure. Embodiments described herein may be implemented into the system using any suitably configured hardware and/or software. FIG. 5 illustrates the system 700 including a radio frequency (RF) circuitry 710, a baseband circuitry 720, an processing unit 730, a memory/storage 740, a display 750, a camera 760, a sensor 770, and an input/output (I/O) interface 780, coupled with each other as illustrated.

The processing unit 730 may include a circuitry, such as, but not limited to, one or more single-core or multi-core processors. The processors may include any combinations of general-purpose processors and dedicated processors, such as graphics processors and application processors. The processors may be coupled with the memory/storage and configured to execute instructions stored in the memory/storage to enable various applications and/or operating systems running on the system.

The baseband circuitry 720 may include a circuitry, such as, but not limited to, one or more single-core or multi-core processors. The processors may include a baseband processor. The baseband circuitry may handle various radio control functions that enable communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with 5G NR, LTE, an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry. In various embodiments, the baseband circuitry 720 may include circuitry to operate with signals that are not strictly considered as being in a baseband frequency. For example, in some embodiments, baseband circuitry may include circuitry to operate with signals having an intermediate frequency, which is between a baseband frequency and a radio frequency.

The RF circuitry 710 may enable communication with wireless networks using modulated electromagnetic radiation through a non-solid medium. In various embodiments, the RF circuitry may include switches, filters, amplifiers, etc. to facilitate the communication with the wireless network. In various embodiments, the RF circuitry 710 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to the UE, eNB, or gNB may be embodied in whole or in part in one or more of the RF circuitries, the baseband circuitry, and/or the processing unit. As used herein, “circuitry” may refer to, be part of, or include an Application Specific Integrated Circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules. In some embodiments, some or all of the constituent components of the baseband circuitry, the processing unit, and/or the memory/storage may be implemented together on a system on a chip (SOC).

The memory/storage 740 may be used to load and store data and/or instructions, for example, for system. The memory/storage for one embodiment may include any combination of suitable volatile memory, such as dynamic random access memory (DRAM)), and/or non-volatile memory, such as flash memory. In various embodiments, the I/O interface 780 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface.

In various embodiments, the sensor 770 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite. In various embodiments, the display 750 may include a display, such as a liquid crystal display and a touch screen display. In various embodiments, the system 700 may be a mobile computing device such as, but not limited to, a laptop computing device, a tablet computing device, a netbook, an ultrabook, a smartphone, etc. In various embodiments, system may have more or less components, and/or different architectures. Where appropriate, methods described herein may be implemented as a computer program. The computer program may be stored on a storage medium, such as a non-transitory storage medium.

The embodiment of the present disclosure is a combination of techniques/processes that can be adopted in 3GPP specification to create an end product.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan. A person having ordinary skill in the art can use different ways to realize the function for each specific application while such realizations should not go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

The disclosed method provides flexible QoS management based on sidelink traffic types. Sidelink transmission of each traffic type may have configurable priority to meet different communication cases and QoS requirements according to the disclosure.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

What is claimed is:

1. A sidelink prioritization method executable in a user equipment (UE), comprising:
receiving an initial priority value of a sidelink service;
determining a traffic type of the side link channel; and
generating a refined priority value of the sidelink service from the initial priority value according to the traffic type of the sidelink service.

2. The method of claim 1, wherein the sidelink service is associated with a priority offset, and the refined priority value of the sidelink service is generated from calculation of the initial priority value and the priority offset.

3. The method of claim 2, wherein the sidelink service is associated with a logical channel group which is further associated with the priority offset.

4. The method of claim 2, wherein the traffic type of the sidelink service is one of traffic types of unicast, groupcast, and broadcast, the priority offset is assigned a first value when the traffic type of the sidelink service is unicast, the priority offset is assigned a second value when the traffic type of the sidelink service is groupcast, and the priority offset is assigned a third value when the traffic type of the sidelink service is broadcast.

5. The method of claim 2, wherein the traffic type of the sidelink service is one of traffic types of unicast and non-unicast, the non-unicast comprises a traffic type of groupcast and a traffic type of broadcast, the priority offset is assigned a unicast offset value when the traffic type of the sidelink service is unicast, the priority offset is assigned a non-unicast offset value when the traffic type of the sidelink service is non-unicast.

6. The method of claim 5, wherein the priority offset is assigned a first groupcast offset value when the traffic type of the sidelink service is groupcast associated with a groupcast group having a number of group members no greater than a threshold, and the priority offset is assigned a second groupcast offset value when the traffic type of the sidelink service is groupcast associated with a groupcast group having a number of group members greater than the threshold.

7. The method of claim 1, wherein the initial priority value of the sidelink service is represented by a ProSe per-packet priority (PPPP), a ProSe per-packet reliability (PPPR), or a combination of the PPPP and PPPR.

8. The method of claim 1, wherein the initial priority value of the sidelink service is a priority used in access stratum (AS), non-access stratum (NAS), or logical channel allocation.

9. The method of claim 1, wherein the initial priority value of the sidelink service is represented by a channel busy ratio (CBR) range index.

10. The method of claim 9, wherein the traffic type of the sidelink service is one of a number of traffic types, at least one of parameters cbr-RangeCommonConfigList-r14 and cbr-ConfigIndex-r14 are obtained based on the number of the traffic types.

11. The method of claim 1, wherein the sidelink service is one of a plurality of sidelink logical channels belonging to a selected ProSe destination, and the method further comprises:
allocating resources to one of the plurality of sidelink logical channels with the highest priority in a specific traffic type selected from a number of traffic types associated with the plurality of sidelink logical channels; and
serving the plurality of sidelink logical channels belonging to the selected ProSe destination according to priority arrangement in each of the number of traffic types until either data for the sidelink logical channels or sidelink grant is exhausted.

12. A sidelink prioritization method executable in a base station, comprising: receiving an initial priority value of a sidelink service;
determining a traffic type of the side link channel;
generating a refined priority value of the sidelink service from the initial priority value according to the traffic type of the sidelink service; and
providing the refined priority value as a part of sidelink control information (SCI) associated with the sidelink service.

13. The method of claim 12 further comprising:
generating the refined priority value of the sidelink service from the initial priority value minus a value of a parameter PriorityFlag, wherein the parameter PriorityFlag is determined based on the traffic type.

14. The method of claim 13, wherein the PriorityFlag represents a level of priority adjustment according to a formula of:
$$\text{PriorityFlag} = \left\{\begin{matrix}00 , n o c h a n g e o n P P P P \\ 01 , p r i o r i t y u p g r a d e b y 1 l e v e l \\ 10 , p r i o r i t y u p g r a d e b y 2 l e v e l s \\ 11 , p r i o r i t y u p d a t e b y 3 l e v e l s\end{matrix}\right)$$
.

15. The method of claim 12 further comprising:
providing an identifier of the traffic type as a part of the SCI associated with the sidelink service.

16. The method of claim 12, wherein the initial priority value of the sidelink service is represented by a ProSe per-packet priority (PPPP), a ProSe per-packet reliability (PPPR), or a combination of the PPPP and PPPR.

17. The method of claim 12, wherein the initial priority value of the sidelink service is a priority used in access stratum (AS), non-access stratum (NAS), or logical channel allocation.

18. The method of claim 12, wherein the initial priority value of the sidelink service is represented by a channel busy ratio (CBR) range index.

19. A user equipment (UE) device, comprising:
a processor configured for executing a sidelink prioritization method of claim 1 .

20. (canceled)

21. (canceled)

22. (canceled)

23. (canceled)

24. (canceled)

25. (canceled)

26. (canceled)

27. (canceled)

28. (canceled)

29. (canceled)

30. A base station, comprising:
a processor configured for executing a sidelink prioritization method of claim 12.

31. (canceled)

32. (canceled)

33. (canceled)

34. (canceled)

35. (canceled)

36. (canceled)
